(19) United States
(12) Patent Application Publication
(10) Pub. No.: US 2026/0106937 A1
(43) Pub. Date: Apr. 16, 2026

(54) METHODS AND SYSTEMS FOR INCREASING EFFECTIVENESS OF COMMUNICATION BETWEEN CONTACT CENTER AGENTS AND CUSTOMERS

(71) Applicant: Trampoline, Inc., Mill Valley, CA (US)

(72) Inventors: Michael Robert Bourke, JR., Corte Madera, CA (US); Gordon Thomas Sween, Minneapolis, MN (US); Yusuf Baktir, Allen, TX (US); Michael Golinkoff, Ardmore, PA (US); Leann Doreen Arkema Cohen, Anacortes, WA (US); Jason Fama, San Carlos, CA (US)

(73) Assignee: Trampoline, Inc., Mill Valley, CA (US)

(21) Appl. No.: 19/224,839

(22) Filed: Jun. 1, 2025

Related U.S. Application Data
(63) Continuation of application No. 18/912,472, filed on Oct. 10, 2024, now abandoned.

(51) Int. Cl. H04M 3/51; G10L 15/26

(52) U.S. Cl. CPC H04M 3/5175; G10L 15/26; H04M 2203/401; H04M 2203/402; H04M 2203/403

(57) ABSTRACT

Methods and systems for increasing effectiveness of communication between an agent of a contact center (such as a healthcare service center or healthcare contact center) and a customer (such as a member of a healthcare plan) are provided. The methods and systems generally utilize artificial intelligence (AI) models, such as large language models (LLMs), to supplement the information available to an agent of a service center during their interaction with a customer.

### BACKGROUND OF THE INVENTION

Customers (e.g., members of healthcare plans) make millions of calls and communications to contact centers (e.g., healthcare service centers or healthcare contact centers) every day. In most cases, the customers interact with one or more agents of the contact centers. Numerous problems may arise from these interactions. For instance, an interaction between a customer and an agent may cover a large variety of topics, take turns to unexpected topics, or veer off on unexpected tangents. This can lead to agents forgetting to obtain important information from the customer or forgetting to convey important information to the customer. As another example, important information associated with the customer's account (e.g., the member's particular healthcare plan) may be scattered across a variety of documents, making it difficult to quickly locate information that is relevant to that particular customer. In healthcare contact centers, this problem may be exacerbated by the enormous number of different healthcare plans that may be serviced by a given healthcare contact center. As a further example, the high volume of communications to contact centers may make it difficult for managers of contact centers to provide sufficient training to agents of those contact centers.

### BRIEF DESCRIPTION OF THE DRAWINGS

Various embodiments of the invention are disclosed in the following detailed description and the accompanying drawings.

FIG. 1 shows a flowchart depicting a first exemplary method for increasing effectiveness of communication between an agent of a contact center and a customer.

FIG. 2 shows a flowchart depicting a second exemplary method for increasing effectiveness of communication between an agent of a contact center and a customer.

FIG. 3 shows a flowchart depicting a third exemplary method for increasing effectiveness of communication between an agent of a contact center and a customer.

FIG. 4 shows a block diagram of a computer system used in some embodiments to perform portions of methods for increasing effectiveness of communication between an agent of a contact center and a customer.

FIG. 5 shows an example of real-time updating of a checklist-based interaction guide and summarization of healthcare plan information in response to artificial intelligence (AI) analysis of a captured text from a digital interaction or real-time transcript of an interaction between an agent of a healthcare contact center and a member of a healthcare plan.

FIG. 6 shows an example of AI feedback provided to agents of healthcare contact centers following interactions with members of healthcare plans.

FIG. 7 shows an example of interaction summaries that may be provided to supervisors of healthcare contact centers.

FIG. 8 shows an example of how a simulated interaction between an agent of a healthcare contact center and a simulated member of a healthcare plan can be generated.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “or” shall convey both disjunctive and conjunctive meanings, unless any such meaning is impossible. For instance, the phrase “A or B” shall be interpreted to include element A alone, element B alone, and the combination of elements A and B, unless any such meaning is impossible. Similarly, the phrase “A, B, or C” shall be interpreted to include element A alone, element B alone, element C alone, the combination of elements A and B but not C, the combination of elements A and C but not B, the combination of elements B and C but not A, and the combination of elements A, B, and C, unless any such meaning is impossible.

Unless otherwise specified, a range of values, when recited, includes both the upper and lower limits of the range, as well as any sub-ranges therebetween. Unless indicated otherwise, terms such as “first,” “second,” etc. are only used to distinguish one element from another. For example, one node could be termed a “first node” and similarly, another node could be termed a “second node,”or vice versa.

Unless indicated otherwise, the term “about,” “thereabout,” “approximately,” etc. means that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGs. It should be recognized that the spatially relative terms are intended to encompass different orientations in addition to the orientation depicted in the FIGs. For example, if an object in the FIGs. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The present disclosure recognizes that numerous problems may arise from interactions between customers (e.g., members of healthcare plans) and agents of contact centers (e.g., healthcare service centers or healthcare contact centers). The present disclosure provides methods and systems for increasing effectiveness of communication between an agent of a contact center and a customer. The methods and systems generally utilize artificial intelligence (AI) models, such as large language models (LLMs), to supplement the information available to an agent of a contact center during their interaction with a customer.

For instance, an interaction between a customer and an agent may cover a large variety of topics, take turns to unexpected topics, or veer off on unexpected tangents. This can lead to agents forgetting to obtain important information from the customer or forgetting to convey important information to the customer. Thus, the problem of agents forgetting to obtain important information from customers or forgetting to convey important information to a customer is solved by methods and systems that utilize AI models to analyze a captured text or a transcription of the interaction, determine whether key events have occurred in the interaction, and update an interaction guide (e.g., a checklist) for the interaction based on the occurrence of such key events.

As another example, important information associated with the customer's account (e.g., a member's particular healthcare plan) may be scattered across a variety of documents, making it difficult to quickly locate information that is relevant to that particular customer. In healthcare contact centers, this problem may be exacerbated by the substantial length of such documents and the enormous number of different healthcare plans that may be serviced by a given healthcare contact center. For instance, even a single employer may offer dozens of different employer-sponsored healthcare plans with different levels of access to care, different cost-splitting structures (e.g., different premiums, deductibles, and co-pays), and the like. Thus, the problem of important information associated with the customer's account being scattered across a variety of documents is solved by methods and systems that utilize AI models to summarize information from one or more documents associated with the customer's account and presenting the summary to the agent.

As a further example, the high volume of communications, contacts, or interactions including for example, chat messages, text messages, emails, or calls to contact centers may make it difficult for managers of contact centers to provide sufficient training to agents of those contact centers. Thus, the problem of insufficient training for agents of those contact centers is solved by methods and systems that utilize AI models to generate simulated interactions between the agents and simulated customers and permitting the agent to respond to the simulated interactions, thereby providing the agent with simulated experience in conducting an interaction with a customer.

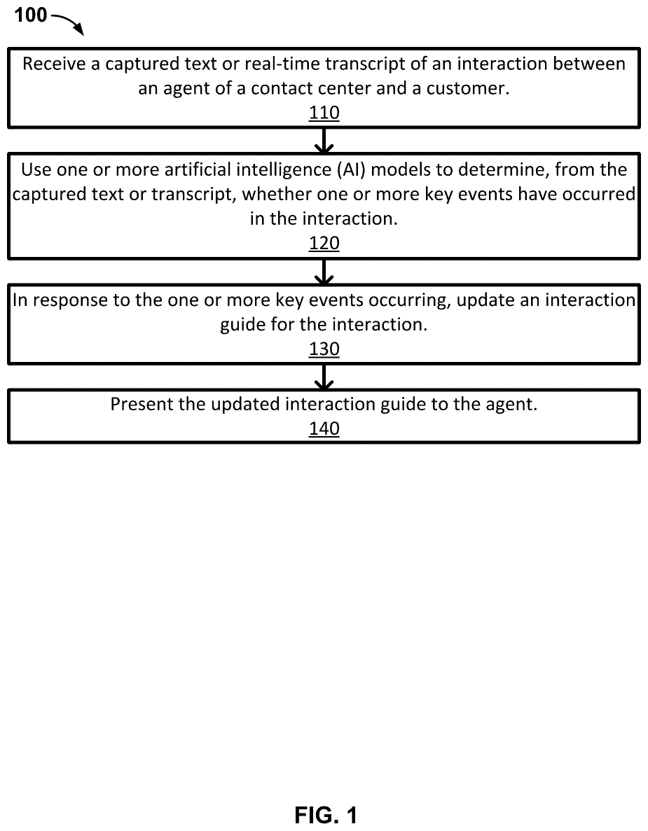

FIG. 1 shows a flowchart depicting a first exemplary method 100 for increasing effectiveness of communication between an agent of a contact center and a customer. In the example shown, a captured text from a digital interaction or a real-time transcript of an interaction between an agent of a contact center and a customer is received at 110. In some embodiments, the customer comprises a member of a healthcare plan. In some embodiments, the contact center comprises a healthcare service center. In some embodiments, the contact center comprises a call center. That is, in some embodiments, the interaction between the agent and the customer is conducted telephonically. In some embodiments, the telephonic interaction is transcribed in real-time to provide a real-time transcript. In other embodiments, the interaction between the agent and the customer is a non-voice interaction such as, for example, a digital interaction. As an example, in some embodiments, the contact center comprises an online chat center. That is, in some embodiments, the interaction between the agent and the customer is conducted via online chat. In some embodiments, the contact center comprises a text center. That is, in some embodiments, the interaction between the agent and the customer is conducted via text message.

At 120, one or more AI models are used to determine, from the captured text or transcript, whether one or more key events have occurred in the interaction. In some embodiments, the one or more AI models comprise one or more LLMs. In some embodiments, the one or more key events comprise the agent asking one or more questions of or providing one or more comments to the customer. In some embodiments, the one or more key events comprise the agent answering one or more questions or one or more comments presented by the customer to the agent. Thus, in some embodiments, the one or more AI models may determine, from the captured text or real-time transcript, that the agent has answered one or more questions presented by the customer. In some embodiments, the one or more key events comprise the customer answering one or more questions presented by the agent to the customer. Thus, in some embodiments, the one or more AI models may determine, from the captured text or real-time transcript, that the customer has answered one or more questions presented by the agent. In some embodiments, the one or more key events comprise the customer asking one or more questions of or providing one or more comments to the agent. Thus, in some embodiments, the one or more AI models may determine, from the captured text or real-time transcript, that the customer has asked one or more questions of the agent.

At 130, an interaction guide for the interaction is updated in response to the one or more key events occurring. In some embodiments, the interaction guide comprises a visual representation of important topics that should be covered during the interaction, important information that should be obtained from the customer, important information that should be conveyed to the customer, or the like. In some embodiments, the interaction guide comprises a checklist that is presented to the agent. Thus, in some embodiments, updating the interaction guide comprises checking off one or more checkboxes in the interaction guide in response to the one or more key events. For instance, in some embodiments, the one or more checkboxes may be checked off when the agent asks one or more questions of the customer, when the agent answers one or more questions presented by the customer, or when the customer answers one or more questions presented by the agent. In some embodiments, updating the interaction guide comprises adding one or more checkboxes in the interaction guide in response to the one or more key events. For instance, in some embodiments, the one or more checkboxes may be added when the customer asks one or more questions of the agent.

At 140, the updated interaction guide is presented to the agent.

In some embodiments, the method 100 comprises repeating any 1, 2, 3, or 4 of operations 110, 120, 130, and 140 one or more times. For instance, in some embodiments, any 1, 2, 3, or 4 of operations 110, 120, 130, and 140 are repeated at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more times, at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 times, or a number of times that is within a range defined by any two of the preceding values. In some embodiments, such repetition permits the one or more AI models to continuously probe the captured text or real-time transcript for an indication that the one or more key events have occurred and to continuously update the interaction guide in response.

In some embodiments, the method 100 further comprises using the one or more AI models to generate the real-time transcript. In some embodiments, the one or more AI models generate the real-time transcript prior to each instance of operation 110. In some embodiments, the same AI model is used to both generate the real-time transcript and to determine, from the transcript, whether the one or more key events have occurred in the interaction. In some embodiments, a first AI model is used to generate the real-time transcript and a second AI model different from the first AI model is used to determine, from the transcript, whether the one or more key events have occurred in the interaction.

In some embodiments, the method 100 further comprises using the one or more AI models to generate a summary of the interaction. In some embodiments, the same AI model is used to generate the summary, to generate the real-time transcript, and to determine, from the transcript, whether the one or more key events have occurred in the interaction. In some embodiments, a first AI model is used to generate the summary and to generate the real-time transcript and a second AI model different from the first AI model is used to determine, from the transcript, whether the one or more key events have occurred in the interaction. In some embodiments, a first AI model is used to generate the summary, a second AI model different from the first AI model is used to generate the real-time transcript, and a third AI model different from the first and second AI models is used to determine, from the transcript, whether the one or more key events have occurred in the interaction.

In some embodiments, the method 100 further comprises presenting the summary to the agent. In some embodiments, presenting the summary to the agent permits the agent to review and learn from the interaction.

In some embodiments, the method 100 further comprises presenting the summary to a supervisor of the agent. In some embodiments, presenting the summary to the supervisor permits the supervisor to provide further training to the agent, thereby permitting the agent to learn from the interaction.

In some embodiments, the method 100 further comprises using the one or more AI models to perform a sentiment analysis procedure on the interaction. In some embodiments, the sentiment analysis procedure determines a set of emotional states, each corresponding to an emotional state of the customer during each a corresponding portion of the interaction. In some embodiments, the same AI model is used to perform the sentiment analysis, to generate the summary, to generate the real-time transcript, and to determine, from the transcript, whether the one or more key events have occurred in the interaction. In some embodiments, a first AI model is used to perform the sentiment analysis, a second AI model different from the first AI model is used to generate the summary and to generate the real-time transcript, and a third AI model different from the first AI model and the second AI model is used to determine, from the transcript, whether the one or more key events have occurred in the interaction. In some embodiments, a first AI model is used to perform the sentiment analysis, a second AI model different from the first AI model is used to generate the summary, a third AI model different from the first AI model and the second AI model is used to generate the real-time transcript, and a fourth AI model different from the first AI model, the second AI model, and the third AI model is used to determine, from the transcript, whether the one or more key events have occurred in the interaction.

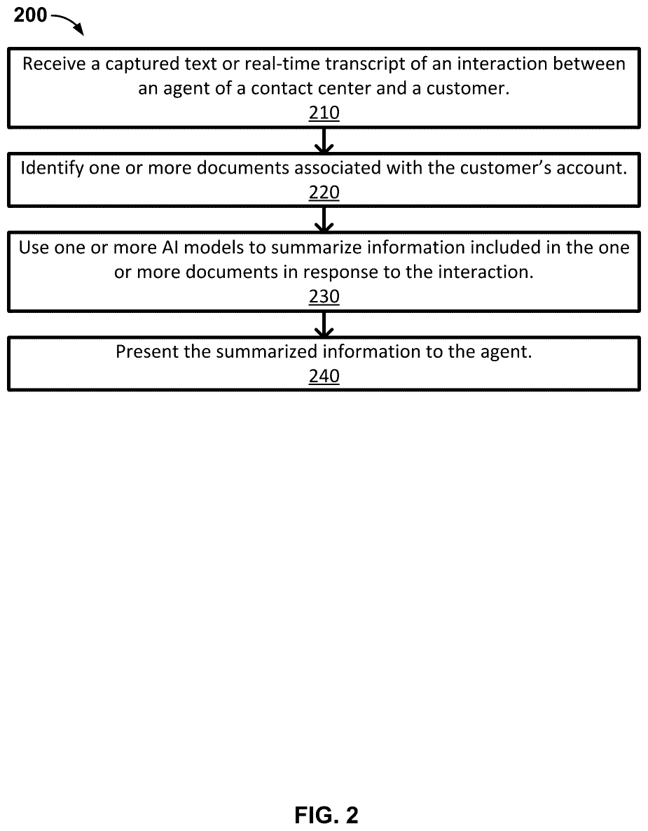

FIG. 2 shows a flowchart depicting a second exemplary method 200 for increasing effectiveness of communication between an agent of a contact center and a customer. In the example shown, a captured text from a digital interaction or real-time transcript of an interaction between an agent of a contact center and a customer is received at 210. In some embodiments, the customer comprises a member of a healthcare plan. In some embodiments, the contact center comprises a healthcare service center. In some embodiments, the contact center comprises a call center. That is, in some embodiments, the interaction between the agent and the customer is conducted telephonically. In some embodiments, the telephonic interaction is transcribed in real-time to provide a real-time transcript. In other embodiments, the interaction between the agent and the customer is a non-voice interaction such as, for example, a digital interaction. As an example, in some embodiments, the contact center comprises an online chat center. That is, in some embodiments, the interaction between the agent and the customer is conducted via online chat. In some embodiments, the contact center comprises a text center. That is, in some embodiments, the interaction between the agent and the customer is conducted via text message.

At 220, one or more documents associated with the customer's account are identified. In some embodiments, the one or more documents associated with the customer's account comprise one or more documents associated with the member's specific healthcare plan. In some embodiments, the one or more documents are identified based on identifying information associated with the customer. In some embodiments, the identifying information comprises any 1, 2, 3, 4, 5, 6, 7, 8, 9 or 10 of: an ID number associated with the customer, a medical record associated with the customer, a first name of the customer, a last name of the customer, a date of birth of the customer, an address associated with the customer, a telephone number associated with the customer, an email address associated with the customer, a social security number of the customer and the last four digits of a social security number of a customer. In some embodiments, such identifying information is associated with the member's specific healthcare plan. Thus, in some embodiments, such identifying information can be used first to identify the member's specific healthcare plan and second to identify one or more documents associated with the member's specific healthcare plan. In some embodiments, the one or more documents are identified based on file names, labels, or metadata associated with the one or more documents. For instance, in some embodiments, the one or more documents contain file names, labels, or metadata indicating that the one or more documents are associated with the healthcare plan. As an example, if the healthcare plan is referred to as “PPO A,” the one or more documents may use file names containing the phrase “PPO A” or a similar descriptor, labels containing the phrase “PPO A” or a similar descriptor, or metadata containing the phrase “PPO A” or a similar descriptor. In some embodiments, the one or more documents are grouped or stored together (e.g., in the same or a similar electronic folder location). In some embodiments, one or more AI models are used to identify the healthcare plan information. In some embodiments, the one or more AI models comprise one or more LLMs.

In some embodiments, only documents that are associated with the customer's account (e.g., only documents that are associated with the member's healthcare plan) are identified and utilized. That is, in some embodiments, documents that are not associated with the customer's account (e.g., documents associated with other healthcare plans) are not identified or utilized. In some embodiments, identifying and utilizing only documents that are associated with the customer's account drastically reduces the amount of information that must be searched or analyzed by one or more AI models and thus greatly increases the efficiency of such a search or analysis.

At 230, one or more AI models are used to summarize information ( ) included in the one or more documents in response to the interaction. In some embodiments, the one or more AI models comprise one or more LLMs. In some embodiments, the one or more AI models summarize the plan information based on any 1, 2, 3, or 4 of: the agent asking one or more questions of or providing one or more comments to the customer, the agent answering one or more questions or one or more comments presented by the customer to the agent, the customer answering one or more questions or one or more comments presented by the agent to the customer, and the customer asking one or more questions of or providing one or more comments to the agent. In some embodiments, the same AI model is used to both identify the information and to summarize the information. In some embodiments, a first AI model is used to identify the information and a second AI model different from the first AI model is used to summarize the information.

In some embodiments, the information comprises healthcare plan information. In some embodiments, the healthcare plan information comprises limits of coverage associated with the healthcare plan. In some embodiments, the information from the one or more documents include details on procedures such as cost, copayments, limitations, preauthorization requirements, plan premiums and deductibles, and process questions like how to file claims.

At 240, the summarized information is presented to the agent.

In some embodiments, the method 200 comprises repeating any 1, 2, 3, or 4 of operations 210, 120, 230, and 240 one or more times. For instance, in some embodiments, any 1, 2, 3, or 4 of operations 210, 220, 230, and 240 are repeated at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more times, at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 times, or a number of times that is within a range defined by any two of the preceding values. In some embodiments, such repetition permits the one or more AI models to continuously probe the one or more documents and to continuously summarize information from the one or more documents as needed during the interaction.

In some embodiments, the method 200 further comprises using the one or more AI models to generate the real-time transcript. In some embodiments, the one or more AI models generate the real-time transcript prior to each instance of operation 210. In some embodiments, the same AI model is used to generate the real-time transcript, to identify the information, and to summarize the information. In some embodiments, a first AI model is used to generate the real-time transcript and a second AI model different from the first AI model is used to identify the information and to summarize the information. In some embodiments, a first AI model is used to generate the real-time transcript, a second AI model different from the first AI model is used to identify the information, and a third AI model different from the first AI model and the second AI model is used to summarize the information.

In some embodiments, the method 200 further comprises using the one or more AI models to generate a summary of the interaction. In some embodiments, the same AI model is used to generate the summary, to generate the real-time transcript, to identify the information, and to summarize the information. In some embodiments, a first AI model is used to generate the summary, to generate the real-time transcript, and to summarize the information and a second AI model different from the first AI model is used to identify the information. In some embodiments, a first AI model is used to generate the summary and to summarize the information, a second AI model different from the first AI model is used to generate the real-time transcript, and a third AI model different from the first AI model and the second AI model is used to identify the information. In some embodiments, a first AI model is used to generate the summary, a second AI model different from the first AI model is used to generate the real-time transcript, a third AI model different from the first AI model and the second AI model is used to identify information, and a fourth AI model different from the first AI model, the second AI model, and the third AI model is used to summarize the information.

In some embodiments, the method 200 further comprises presenting the summary to the agent. In some embodiments, presenting the summary to the agent permits the agent to review and learn from the interaction.

In some embodiments, the method 200 further comprises presenting the summary to a supervisor of the agent. In some embodiments, presenting the summary to the supervisor permits the supervisor to provide further training to the agent, thereby permitting the agent to learn from the interaction.

In some embodiments, the method 200 further comprises using the one or more AI models to perform a sentiment analysis procedure on the interaction. In some embodiments, the sentiment analysis procedure determines a set of emotional states, each corresponding to an emotional state of the customer during each a corresponding portion of the interaction. In some embodiments, the same AI model is used to perform the sentiment analysis, to generate the summary, to generate the real-time transcript, to identify the information, and to summarize the information. In some embodiments, a first AI model is used to perform the sentiment analysis, a second AI model different from the first AI model is used to generate the summary, to generate the real-time transcript, and to summarize the information and a third AI model different from the first AI model and the second AI model is used to identify the information. In some embodiments, a first AI model is used to perform the sentiment analysis, a second AI model different from the first AI model is used to generate the summary and to summarize the information, a third AI model different from the first AI model and the second AI model is used to generate the real-time transcript, and a fourth AI model different from the first AI model, the second AI model, and the third AI model is used to identify the information. In some embodiments, a first AI model is used to perform the sentiment analysis, a second AI model different from the first AI model is used to generate the summary, a third AI model different from the first AI model and the second AI model is used to generate the real-time transcript, a fourth AI model different from the first AI model, the second AI model, and the third AI model is used to identify the information, and a fifth AI model different from the first AI model, the second AI model, the third AI model, and the fourth AI model is used to summarize the information.

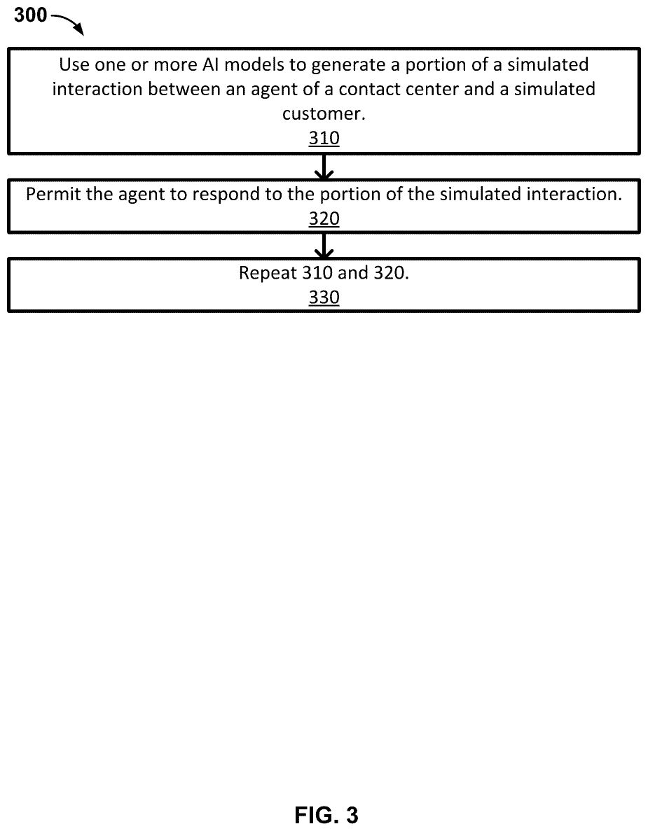

FIG. 3 shows a flowchart depicting a third exemplary method 300 for increasing effectiveness of communication between an agent of a contact center and a customer. In the example shown, one or more AI models are used to generate a portion of a simulated interaction between an agent of a contact center and a simulated customer at 310. In some embodiments, the customer comprises a member of a healthcare plan. In some embodiments, the contact center comprises a healthcare service center. In some embodiments, the contact center comprises a call center. That is, in some embodiments, the simulated interaction between the agent and the simulated customer is conducted telephonically. In some embodiments, the simulated telephonic interaction is transcribed in real-time to provide a real-time transcript. In other embodiments, the simulated interaction between the agent and the customer is a non-voice interaction such as, for example, a digital interaction. As an example, in some embodiments, the contact center comprises an online chat center. That is, in some embodiments, the simulated interaction between the agent and the simulated customer is conducted via online chat. In some embodiments, the contact center comprises a text center. That is, in some embodiments, the simulated interaction between the agent and the simulated customer is conducted via text message.

In some embodiments, the one or more AI models comprise one or more LLMs. In some embodiments, the portion of the simulated interaction is generated based on the agent asking one or more questions of or providing one or more comments to the simulated customer.

At 320, the agent is permitted to respond to the portion of the simulated interaction.

At 330, operations 310 and 320 are repeated one or more times. For instance, in some embodiments, operations 310 and 320 are repeated at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more times, at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 times, or a number of times that is within a range defined by any two of the preceding values. In some embodiments, such repetition permits the one or more agent to conduct a complete simulated interaction with the simulated customer. In some embodiments, the method 300 thereby provides the agent with simulated experience in conducting an interaction with a customer.

In some embodiments, the method 300 further comprises using the one or more AI models to generate a transcript of the simulated interaction. In some embodiments, the same AI model is used to both generate the portions of the simulated interaction and to generate the transcript. In some embodiments, a first AI model is used to generate the portions of the simulated interaction and a second AI model different from the first AI model is used to generate the transcript.

In some embodiments, the method 300 further comprises presenting the transcript to the agent. In some embodiments, presenting the transcript to the agent permits the agent to review and learn from the simulated interaction.

In some embodiments, the method 300 further comprises presenting the transcript to a supervisor of the agent. In some embodiments, presenting the transcript to the supervisor permits the supervisor to provide further training to the agent, thereby permitting the agent to learn from the simulated interaction.

In some embodiments, the method 300 further comprises using the one or more AI models to generate a summary of the simulated interaction. In some embodiments, the same AI model is used to generate the summary, to generate the transcript, and to generate the portions of the simulated interaction. In some embodiments, a first AI model is used to generate the summary and to generate the transcript and a second AI model different from the first AI model is used to generate the portions of the simulated interaction. In some embodiments, a first AI model is used to generate the summary, a second AI model different from the first AI model is used to generate the transcript, and a third AI model different from the first AI model and the second AI model is used to generate the portions of the simulated interaction.

In some embodiments, the method 300 further comprises presenting the summary to the agent. In some embodiments, presenting the summary to the agent permits the agent to review and learn from the simulated interaction.

In some embodiments, the method 300 further comprises presenting the summary to a supervisor of the agent. In some embodiments, presenting the summary to the supervisor permits the supervisor to provide further training to the agent, thereby permitting the agent to learn from the simulated interaction.

The methods described above may be implemented alone or in combination with one another. For instance, in some embodiments, all or a portion of method 100 described herein with respect to FIG. 1 may be combined with all or a portion of method 200 described herein with respect to FIG. 2. In some embodiments, combining all or a portion of method 100 with all or a portion of method 200 solves both the problem of agents of contact centers forgetting to obtain important information from customers or forgetting to convey important information to a customer and the problem of important information associated with the customer's account being scattered across a variety of documents. In some embodiments, combining all or a portion of method 100 with all or a portion of method 200 permits an agent to quickly reference an updated interaction guide (e.g., a checklist) for the interaction based on the occurrence of key events (as described herein with respect to method 100 of FIG. 1) while also permitting the agent to quickly view summarized information (as described herein with respect to method 200 of FIG. 2).

In some embodiments, all or a portion of method 100 described herein with respect to FIG. 1 may be combined with all or a portion of method 300 described herein with respect to FIG. 3. In some embodiments, combining all or a portion of method 100 with all or a portion of method 300 solves both the problem of agents of contact centers forgetting to obtain important information from customers or forgetting to convey important information to a customer and the problem of insufficient training for agents of contact centers. In some embodiments, combining all or a portion of method 100 with all or a portion of method 300 permits an agent to train on quickly referencing an updated interaction guide (e.g., a checklist) for an interaction based on the occurrence of key events (as described herein with respect to method 100 of FIG. 1) while also providing the agent with simulated experience in conducting an interaction with a customer (as described herein with respect to method 300 of FIG. 3).

In some embodiments, all or a portion of method 200 described herein with respect to FIG. 2 may be combined with all or a portion of method 300 described herein with respect to FIG. 3. In some embodiments, combining all or a portion of method 200 with all or a portion of method 300 solves both the problem of important information associated with a customer's account being scattered across a variety of documents and the problem of insufficient training for agents of contact centers. In some embodiments, combining all or a portion of method 200 with all or a portion of method 300 permits an agent to train on quickly viewing summarized information (as described herein with respect to method 200 of FIG. 2) while also providing the agent with simulated experience in conducting an interaction with a customer (as described herein with respect to method 300 of FIG. 3).

In some embodiments, all or a portion of method 100 described herein with respect to FIG. 1, all or a portion of method 200 described herein with respect to FIG. 2, and all or a portion of method 300 described herein with respect to FIG. 3 may be combined. IN some embodiments, combining all or a portion of method 100, all or a portion of method 200, and all or a portion of method 300 solves the problem of agents of contact centers forgetting to obtain important information from customers or forgetting to convey important information to a customer, the problem of important information associated with a customer's account being scattered across a variety of documents, and the problem of insufficient training for agents of contact centers. In some embodiments, combining all or a portion of method 100, all or a portion of method 200, and all or a portion of method 300 permits an agent to train on quickly referencing an updated interaction guide (e.g., a checklist) for an interaction based on the occurrence of key events (as described herein with respect to method 100 of FIG. 1) and to train on quickly viewing summarized information (as described herein with respect to method 200 of FIG. 2) while also providing the agent with simulated experience in conducting an interaction with a customer (as described herein with respect to method 300 of FIG. 3)

Additionally, systems are disclosed that can be used to perform the method 100 of FIG. 1, the method 200 of FIG. 2, the method 300 of FIG. 3, or any of operations 110, 120, 130, and 140, operations 210, 220, 230, and 240, or operations 310, 320, and 330 described herein. In some embodiments, the systems comprise one or more processors and memory coupled to the one or more processors. In some embodiments, the one or more processors are configured to implement one or more operations of method 100, 200, or 300. In some embodiments, the memory is configured to provide the one or more processors with instructions corresponding to the operations of method 100, 200, or 300. In some embodiments, the instructions are embodied in a tangible computer readable storage medium.

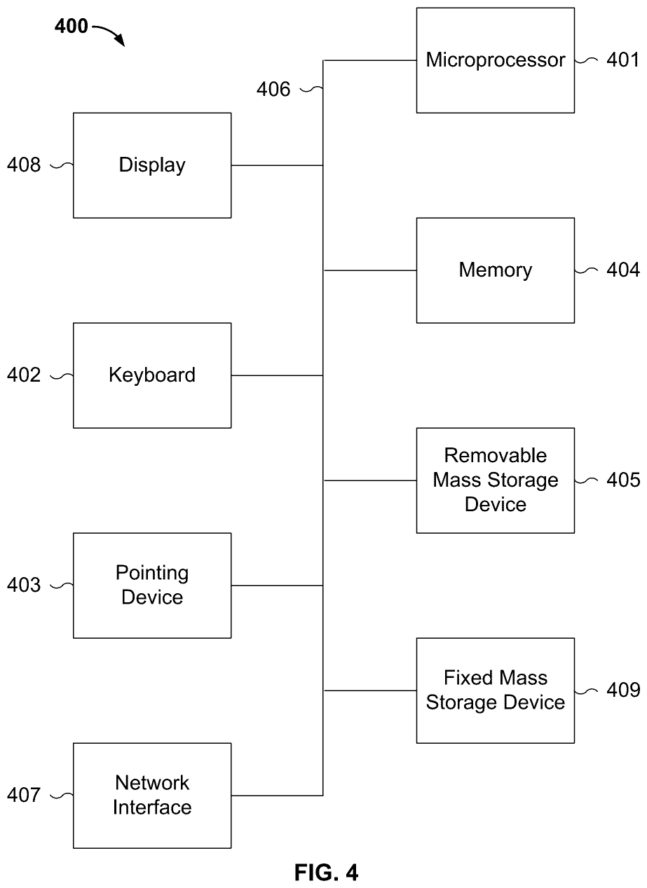

FIG. 4 is a block diagram of a computer system 400 used in some embodiments to perform portions of methods for increasing effectiveness of communication between an agent of a contact center and a customer described herein (such as operation 110, 120, 130, or 140 of method 100 as described herein with respect to FIG. 1, operation 210, 220, 230, or 240 of method 200 as described herein with respect to FIG. 2, or operation 310, 320, or 330 of method 300 as described herein with respect to FIG. 3). FIG. 4 illustrates one embodiment of a general purpose computer system. Other computer system architectures and configurations can be used for carrying out the processing of the inventions described herein. Computer system 400, made up of various subsystems described below, includes at least one microprocessor subsystem 401. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 400. Using instructions retrieved from memory 404, the microprocessor subsystem controls the reception and manipulation of input data, and the output and display of data on output devices.

The microprocessor subsystem 401 is coupled bi-directionally with memory 404, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 404 may include any suitable computer-readable storage media, described below, depending on whether, for example, data access needs to be bi-directional or uni-directional. The microprocessor subsystem 401 can also directly and very rapidly retrieve and store frequently needed data in a cache memory (not shown).

A removable mass storage device 405 provides additional data storage capacity for the computer system 400, and is coupled either bi-directionally (read/write) or uni-directionally (read only) to microprocessor subsystem 401. Storage 405 may also include computer-readable media such as magnetic tape, flash memory, signals embodied on a carrier wave, PC-CARDS, portable mass storage devices, holographic storage devices, and other storage devices. A fixed mass storage 409 can also provide additional data storage capacity. The most common example of mass storage 409 is a hard disk drive. Mass storage 405 and 409 generally store additional programming instructions, data, and the like that typically are not in active use by the processing subsystem. It will be appreciated that the information retained within mass storage 405 and 409 may be incorporated, if needed, in standard fashion as part of primary storage 404 (e.g., RAM) as virtual memory.

In addition to providing processing subsystem 401 access to storage subsystems, bus 406 can be used to provide access other subsystems and devices as well. In the described embodiment, these can include a display monitor 408, a network interface 407, a keyboard 402, and a pointing device 403, as well as an auxiliary input/output device interface, a sound card, speakers, and other subsystems as needed. The pointing device 403 may be a mouse, stylus, track ball, or tablet, and is useful for interacting with a graphical user interface.

The network interface 407 allows the processing subsystem 401 to be coupled to another computer, computer network, or telecommunications network using a network connection as shown. Through the network interface 407, it is contemplated that the processing subsystem 401 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 401 can be used to connect the computer system 400 to an external network and transfer data according to standard protocols. That is, method embodiments of the present invention may execute solely upon processing subsystem 401, or may be performed across a network such as the Internet, intranet networks, or local area networks, in conjunction with a remote processing subsystem that shares a portion of the processing. Additional mass storage devices (not shown) may also be connected to processing subsystem 401 through network interface 407.

An auxiliary I/O device interface (not shown) can be used in conjunction with computer system 400. The auxiliary I/O device interface can include general and customized interfaces that allow the processing subsystem 401 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 4 is but an example of a computer system suitable for use with the invention. Other computer systems suitable for use with the invention may include additional or fewer subsystems. In addition, bus 408 is illustrative of any interconnection scheme serving to link the subsystems. Other computer architectures having different configurations of subsystems may also be utilized.

### EXAMPLES

### Example 1: Real-Time Updating of a Checklist-Based Interaction Guide and Summarization of Healthcare Plan Information

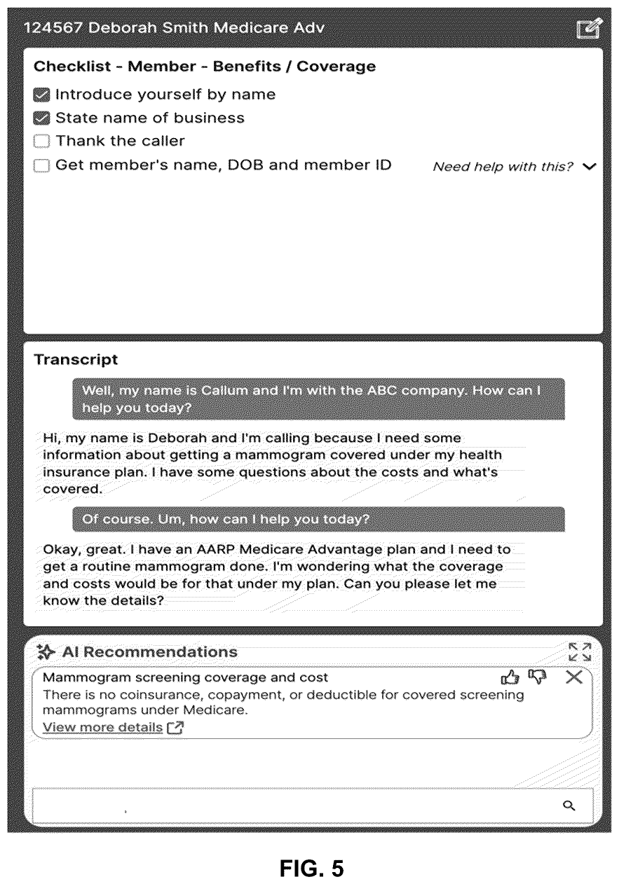

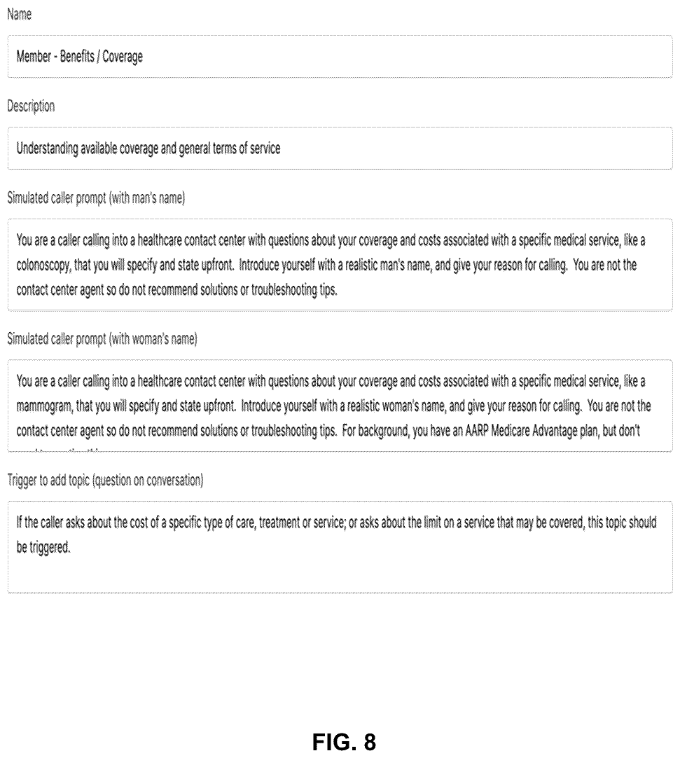

FIG. 5 shows an example of real-time updating of a checklist-based interaction guide and summarization of healthcare plan information in response to AI analysis of a captured text from a digital interaction or a real-time transcript of an interaction between an agent of a healthcare contact center and a member of a healthcare plan. In the example shown, the captured text or transcript is generated from a simulated interaction from a prompt as described in further detail herein with respect to FIG. 8.

As shown in FIG. 5, a checklist is presented to the agent. As the agent interacts with the member and various key events (e.g., the agent introducing themself by name to the member, the agent stating the name of the business, etc.), various checkboxes are checked off. A real-time checklist from which the occurrence of key events is noted is shown below. Furthermore, summarized healthcare plan information (e.g., that there is no coinsurance, copayment, or deductible for covered screening mammograms under Medicare) is provided in response to questions asked by the member.

At the top of the page, Member Identification and Benefit Packages (health plans, etc.) is displayed. This information can come from interaction metadata or the AI models disclosed herein can detect member details from the captured text or real-time transcript and then fetch the Benefit Package from an eligibility system.

Interaction Topics can be automatically detected from the captured text or real-time transcript in case they are not part of the metadata.

Based on the Interaction Topics, a checklist which walks the agent through the interaction is displayed. The AI models disclosed herein automatically check off items based on interrogating the real time transcript. The agent can click “need help with that” to get more information and links on each item.

As checklist items are checked off, additional checklist items can be added to the list. For example, in a confirm benefits interaction topic, once the customer has provided their id number, a checklist item can be added to confirm the member's benefits. Additional checklist items can also be added based on Insight questions which are not displayed on the list. For example, if a customer says they have not yet chosen a provider, a checklist item to help them find a provider can be added. This results in a dynamic checklist-based workflow tailored to the customer and discussion flow as the conversation evolves.

After the checklist is the real-time transcript and following the transcript are multiple types of AI Recommendations. The AI models described herein can be used to determine the specific question the customer is asking from the captured text or real-time transcript. Then, the AI models described herein can summarize documents scoped to the customer's benefit package that best answer a customer's questions or statements and returns the summary with a link to the full documents from which the summary was generated. Additionally, the agents or supervisors can give feedback on the AI Recommendations generated by the AI models. Such feedback can be used to create context which is part of the AI model's (e.g. an LLM) prompt to create augmented questions and document summaries. In this way, the AI Recommendations improve over time.

Moreover, at the beginning of every interaction, the customer's recent case notes can be retrieved from a healthcare plan's system of record, and a summary of their recent interactions can be presented to the agent for context.

Finally, when the AI models described herein detect that the interaction is about to end, depending on the interaction topic, present preventative care options can be presented to the agent and to the customer based on the customer's history and information. Such options can be aligned to objectives identified by the contact center (e.g., to highlight cancer screenings, focus on immunizations or annual wellness visits, promote programs for eligible patients, etc.)

### Example 2: AI Feedback to Agents of Healthcare Contact Centers Following Interactions with Members of Healthcare Plans

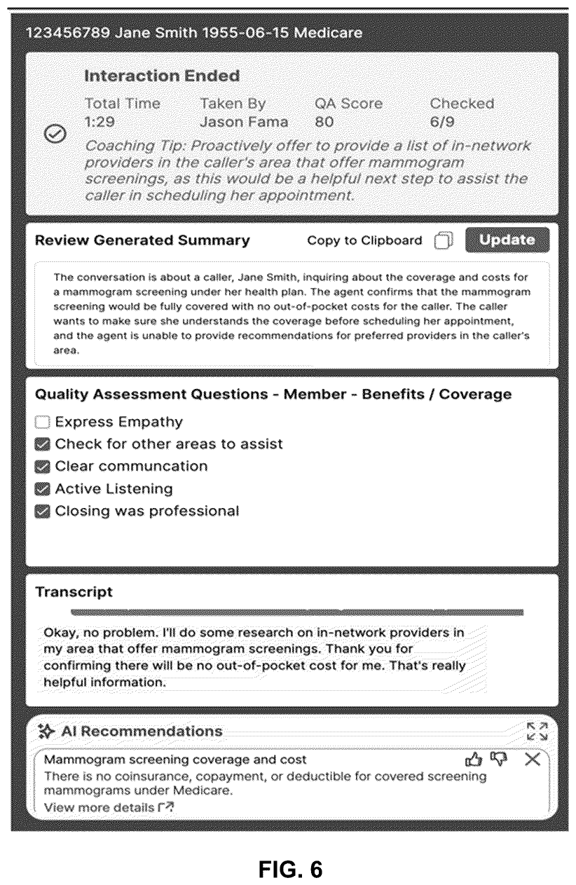

FIG. 6 shows an example of AI feedback provided to agents of healthcare contact centers following interactions with members of healthcare plans. As shown in FIG. 6, following an interaction between an agent and a member, the agent may be presented with AI-generated feedback on the agent's performance during the interaction. For instance, the agent may be shown the total time of the interaction, a quality assessment (QA) score, a number of checkboxes that were checked during the interaction, and the like. The agent may also be shown coaching tips that could improve the agent's performance during a future interaction. A summary of the interaction may be presented to the agent. The agent may be shown a checklist indicating which QA items (such as expressing empathy for the member, checking for other areas in which to provide assistance, communicating clearly, actively listening, closing professionally, and the like) the agent performed successfully. Finally, captured text from a digital interaction or a real-time transcript and AI Recommendations may also be provided to the agent. In this example, as in the example shown in FIG. 5, the captured text or transcript is generated from a simulated interaction from a prompt as described in further detail herein with respect to FIG. 8.

As soon as the interaction ends, the AI models described herein may be used to generate a summary of the interaction and the summary may be displayed to the agent on a post interaction view. This summary may be automatically pushed to the company's system of record for interactions and may also be editable. The original summary and the edited summary may both be retained to provide an audit of changes and to refine the summarization to pick up common edits.

A list of Quality Assessments based on the Interaction Topics detected may be provided. Each question may be evaluated by using the AI models described herein to interrogate the captured text or real-time transcript and evaluate whether each QA criteria was met. Like checklist questions, QA questions may be conditional based on other QA questions or based on insight questions. For example, if the AI models described herein detect that there was escalation during the interaction, a QA question asking if there was an attempt to effectively de-escalate may be added. The QA score may be calculated based on the percentage of QA questions that were checked during the interaction.

### Example 3: Interaction Summaries for Supervisors of Healthcare Contact Centers

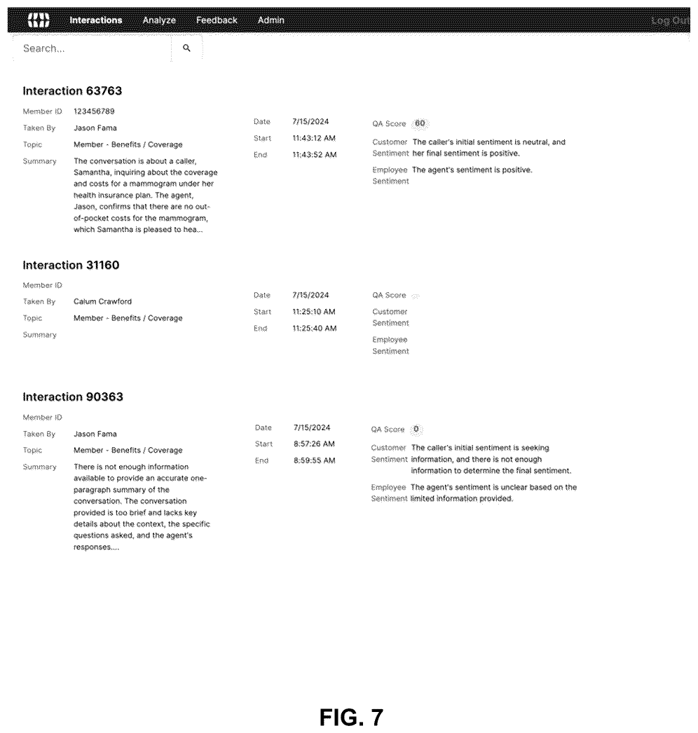

FIG. 7 shows an example of interaction summaries that may be provided to supervisors of healthcare contact centers. As shown in FIG. 7, the supervisors may be presented with summaries of all interactions between agents under their supervision and members of healthcare plans. The summaries may include information such as QA score associated with the interaction, a summary of the member's sentiment during the interaction, and a summary of the agent's sentiment during the interaction.

Additionally, information associated with the summary of each interaction may be provided in graphical form to the supervisors in order to provide an overview of all the interactions for which the supervisor is responsible. This may allow the supervisor to see and filter dashboards on sentiment, call topics, escalations, repeat callers, audit questions, grievances, and insight questions which may be defined per interaction topic (and may thus be referred to as “interaction attributes”) and interrogated for each interaction. For example, an insight question may determine if there is a reference to a member needing to call the healthcare contact center previously on the same topic. Such information may be displayed in an aggregate form to display insights about repeat calls. Supervisors can also create their own dashboards.

### Example 3: Simulated Interaction Between an Agent of a Healthcare Contact Center and a Simulated Member of a Healthcare Plan

FIG. 8 shows an example of how a simulated interaction between an agent of a healthcare contact center and a simulated member of a healthcare plan can be generated. In the example shown, an AI model described herein generates portions of a simulated interaction between the agent and the simulated member. The agent is then permitted to respond to questions or comments from the simulated member. The AI model then generates additional portions of the simulated interaction based on the agent's response.

In this case, as shown in FIG. 8, a name and description can be specified for the simulated interaction. In this example, the name given to the simulated interaction is specified as “Member—Benefits/Coverage” with a description of “Understanding available coverage and general terms of service. ” Additionally, a simulated caller prompt can be used to generate a transcript representing an interaction between an agent of a healthcare contact center and a simulated member of a healthcare plan. Here, a simulated caller prompt (with woman's name) is used to generate the transcripts as shown in FIG. 5 and FIG. 6 for the caller “Deborah” requesting for information about a mammogram. Finally, as shown at the bottom of FIG. 8, a trigger to add topic may be specified, which in this case is specified as whether the caller asks about the cost of a specific type of care.

The simulated interactions may be separated from actual interactions with members. The simulated interactions may provide options to retry an interaction of the same interaction topic if an agent needs more practice or the agent did not achieve 100% on their QA questions. In addition to the QA score at the end of each training interaction, the agent may receive more comprehensive feedback and coaching that they can use to improve their performance on subsequent tries. Scores for agents may be aggregated by call topic across all attempts so that supervisors can see how the agent's competency has trended and when it has reached an acceptable level to take live member interactions for a given topic.

Supervisors may also view recommendations provided by the AI model where the agent (or the supervisor) rejected the AI recommendation and gave feedback as to why it was not helpful. The supervisors can choose to accept or to disregard the feedback. Accepted feedback may then be used to create context and augment the prompts that generate the AI recommendations, augmented questions and document summaries such that the system improves over time.

### Example 4: Sentiment Analysis of an Interaction Between an Agent of a Healthcare Contact Center and a Member of a Healthcare Plan

The methods and systems described herein may be used to provide sentiment analysis to assess a member of a healthcare plan's emotional state at various points during an interaction with an agent of a healthcare contact center. For example, the sentiment analysis may provide a moment-by-moment assessment of whether the member is feeling confused, irritated/frustrated, worried/stressed, or ignorant/information-gathering. Each measure of sentiment may be scored on a scale of, for example, −10 to +10. A display of the member's sentiment score for each such sentiment may be shown to the agent, permitting the agent to understand how the member is feeling at a given time and how the member's feelings are trending over time.

The AI models described herein may provide recommendations to the agent based on the sentiment scores. For instance, the AI models may provide a recommendation such as making sure to understand what the issue is, getting agreement that the understanding is accurate, and then providing the correct information to resolve the confusion when the member appears to be confused. When the member appears to be frustrated, the AI models may provide a recommendation such as expressing to the member that the agent is hearing that they are frustrated, having the member confirm the agent's understanding, and assuring the member that the agent will stay with the member until the issue is resolved or the member understands the next steps needed to resolve the issue. When the member appears to be stressed, the AI models may provide a recommendation such as assuring the member that the agent understands their concerns, that the agent is committed to resolving the issue or coming to a clear plan to resolve the issue, and getting the member the agree that the plan addresses the concern. When the member appears to be ignorant or gathering information, the AI models may provide a recommendation that the agent confirms that they know what the member is trying to achieve, provides the correct information, and confirms that the member agrees with or understands the information.

### EXAMPLES OF EMBODIMENTS

The following are some examples of various embodiments as described herein:
Embodiment 1 A method for increasing effectiveness of communication between an agent of a contact center and a customer, the method comprising:
   a. receiving a captured text or real-time transcript of an interaction between an agent of a contact center and a customer;
   b. using one or more artificial intelligence (AI) models to determine, from the transcript, whether one or more key events have occurred in the interaction;
   c. in response to the one or more key events occurring, updating an interaction guide for the interaction; and
   d. presenting the updated interaction guide to the agent.
Embodiment 2 The method of embodiment 1, wherein the contact center comprises a healthcare call center and wherein the customer comprises a member of a healthcare plan.
Embodiment 3 The method of embodiment 1 or 2, further comprising, prior to (a), using the one or more AI models to generate the real-time transcript.
Embodiment 4 The method of any one of embodiments 1-3, wherein the one or more AI models comprise one or more large language models (LLMs).
Embodiment 5 The method of any one of embodiments 1-4, wherein the one or more key events comprise the agent asking one or more questions of or providing one or more comments to the customer or the agent answering one or more questions or one or more comments presented by the customer to the agent.
Embodiment 6 The method of any one of embodiments 1-5, wherein the one or more key events comprise the customer answering one or more questions presented by the agent to the customer.
Embodiment 7 The method of embodiment 5 or 6, wherein (c) comprises checking off one or more checkboxes in the interaction guide in response to the one or more key events.
Embodiment 8 The method of any one of embodiments 1-7, wherein the one or more key events comprise the customer asking one or more questions of or providing one or more comments to the agent.
Embodiment 9 The method of embodiment 8, wherein (c) comprises adding one or more checkboxes in the interaction guide in response to the one or more key events.
Embodiment 10 The method of any one of embodiments 1-9, further comprising repeating (a)-(d) one or more times.
Embodiment 11 The method of any one of embodiments 1-10, further comprising using the one or more AI models to generate a summary of the interaction.
Embodiment 12 The method of embodiment 11, further comprising presenting the summary to the agent, thereby permitting the agent to learn from the interaction.
Embodiment 13 The method of embodiment 11 or 12, further comprising presenting the summary to a supervisor of the agent, thereby permitting the supervisor to provide further training to the agent.
Embodiment 14 The method of any one of embodiments 1-12, further comprising using the one or more AI models to perform a sentiment analysis procedure on the interaction to thereby determine a set of emotional states, each corresponding to an emotional state of the customer during each a corresponding portion of the interaction.
Embodiment 15 The method of embodiment 14, further comprising using the one or more AI models to provide feedback to the agent based on the sentiment analysis procedure, thereby permitting the LLM to provide further training to the agent.
Embodiment 16 A method for increasing effectiveness of communication between an agent of a contact center and a customer, the method comprising:
   a. receiving a captured text or real-time transcript of an interaction between an agent of a contact center and a customer;
   b. identifying one or more documents associated with an account of the customer;
   c. using one or more artificial intelligence (AI) models to summarize information included in the one or more documents in response to the interaction; and
   d. presenting the summarized information to the agent.
Embodiment 17 The method of embodiment 16, wherein the contact center comprises a healthcare call center and wherein the customer comprises a member of a healthcare plan.
Embodiment 18 The method of embodiment 16 or 17, further comprising, prior to (a), using the one or more AI models to generate the real-time transcript.
Embodiment 19 The method of any one of embodiments 16-18, wherein the one or more AI models comprises one or more large language models (LLMs).
Embodiment 20 The method of any one of embodiments 16-19, wherein (b) comprises identifying the one or more documents based on identifying information associated with the customer.
Embodiment 21 The method of embodiment 20, wherein the identifying information comprises one or more members selected from the group consisting of: an ID number associated with the customer, a medical record associated with the customer, a first name of the customer, a last name of the customer, a date of birth of the customer, an address associated with the customer, a telephone number associated with the customer, an email address associated with the customer, a social security number of the customer, and the last four digits of a social security number of a customer.
Embodiment 22 The method of any one of embodiments 16-21, wherein (b) comprises using the one or more AI models to identify the information.
Embodiment 23 The method of any one of embodiments 16-22, wherein (c) comprises using the one or more AI models to summarize the information based on one or more members selected from the group consisting of: the agent asking one or more questions of or providing one or more comments to the customer, the agent answering one or more questions or one or more comments presented by the customer to the agent, the customer answering one or more questions or one or more comments presented by the agent to the customer, and the customer asking one or more questions of or providing one or more comments to the agent.
Embodiment 24 The method of any one of embodiments 16-23, wherein the information comprises one or more members selected from the group consisting of: limits of coverage associated with a healthcare plan, details on procedures, cost, copayments, limitations, preauthorization requirements, plan premiums and deductibles, and process questions.
Embodiment 25 The method of any one of embodiments 16-24, further comprising repeating (a)-(d) one or more times.
Embodiment 26 The method of any one of embodiments 16-25, further comprising using the one or more AI models to generate a summary of the interaction.
Embodiment 27 The method of embodiment 26, further comprising presenting the summary to the agent, thereby permitting the agent to learn from the interaction.
Embodiment 28 The method of embodiment 26 or 27, further comprising presenting the summary to a supervisor of the agent, thereby permitting the supervisor to provide further training to the agent.
Embodiment 29 The method of any one of embodiments 16-28, further comprising using the one or more AI models to perform a sentiment analysis procedure on the interaction to thereby determine a set of emotional states, each corresponding to an emotional state of the customer during each a corresponding portion of the interaction.
Embodiment 30 The method of embodiment 29, further comprising using the one or more AI models to provide feedback to the agent based on the sentiment analysis procedure, thereby permitting the LLM to provide further training to the agent.
Embodiment 31 A method for increasing effectiveness of communication between an agent of a contact center and a customer, the method comprising:
   a. using one or more artificial intelligence (AI) models to generate a portion of a simulated interaction between an agent of a contact center and a simulated customer;
   b. permitting the agent to respond to the portion of the simulated interaction; and
   c. repeating (a)-(b) to thereby provide the agent with simulated experience in conducting an interaction with a customer.
Embodiment 32 The method of embodiment 31, wherein the contact center comprises a healthcare call center and wherein the simulated customer comprises a simulated member of a healthcare plan.
Embodiment 33 The method of embodiment 31 or 32, wherein the one or more AI models comprise one or more large language models (LLMs).
Embodiment 34 The method of any one of embodiments 31-33, wherein (a) comprises generating the portion of the simulated interaction based on at least one member selected from the group consisting of: the agent asking one or more questions of or providing one or more comments to the simulated customer and the agent answering one or more questions or one or more comments presented by the simulated customer to the agent.
Embodiment 35 The method of any one of embodiments 31-34, further comprising using the one or more AI models to generate a transcript of the simulated interaction.
Embodiment 36 The method of embodiment 35, further comprising presenting the transcript to a supervisor of the agent, thereby permitting the supervisor to provide further training to the agent.
Embodiment 37 The method of embodiment 35 or 36, further comprising presenting the transcript to the agent, thereby permitting the agent to learn from the simulated interaction.
Embodiment 38 The method of any one of embodiments 31-37, further comprising using the one or more AI models to generate a summary of the simulated interaction.
Embodiment 39 The method of embodiment 38, further comprising presenting the summary to a supervisor of the agent, thereby permitting the supervisor to provide further training to the agent.
Embodiment 40 The method of embodiment 38 or 39, further comprising presenting the summary to the agent, thereby permitting the agent to learn from the simulated interaction.
Embodiment 41 A system for increasing effectiveness of communication between an agent of a contact center and a customer, the system comprising:
   one or more processors; and
   a memory coupled with the one or more processors and configured to provide the one or more processors with instructions which when executed cause the processor to implement a method comprising:
      a. receiving a captured text or real-time transcript of an interaction between an agent of a contact center and a customer;
      b. using one or more artificial intelligence (AI) models to determine, from the transcript, whether one or more key events have occurred in the interaction;
      c. in response to the one or more key events occurring, updating an interaction guide for the interaction; and
      d. presenting the updated interaction guide to the agent.
Embodiment 42 The system of embodiment 41, wherein the contact center comprises a healthcare call center and wherein the customer comprises a member of a healthcare plan.
Embodiment 43 The system of embodiment 41 or 42, wherein the method further comprises, prior to (a), using the one or more AI models to generate the real-time transcript.
Embodiment 44 The system of any one of embodiments 41-43, wherein the one or more AI models comprise one or more large language models (LLMs).
Embodiment 45 The system of any one of embodiments 41-44, wherein the one or more key events comprise the agent asking one or more questions of or providing one or more comments to the customer or the agent answering one or more questions or one or more comments presented by the customer to the agent.
Embodiment 46 The system of any one of embodiments 41-45, wherein the one or more key events comprise the customer answering one or more questions presented by the agent to the customer.
Embodiment 47 The system of embodiment 45 or 46, wherein (c) comprises checking off one or more checkboxes in the interaction guide in response to the one or more key events.
Embodiment 48 The system of any one of embodiments 41-47, wherein the one or more key events comprise the customer asking one or more questions of or providing one or more comments to the agent.
Embodiment 49 The system of embodiment 48, wherein (c) comprises adding one or more checkboxes in the interaction guide in response to the one or more key events.
Embodiment 50 The system of any one of embodiments 41-49, wherein the method further comprises repeating (a)-(d) one or more times.
Embodiment 51 The system of any one of embodiments 41-50, wherein the method further comprises using the one or more AI models to generate a summary of the interaction.
Embodiment 52 The system of embodiment 51, wherein the method further comprises presenting the summary to the agent, thereby permitting the agent to learn from the interaction.
Embodiment 53 The system of embodiment 51 or 52, wherein the method further comprises presenting the summary to a supervisor of the agent, thereby permitting the supervisor to provide further training to the agent.
Embodiment 54 The system of any one of embodiments 41-52, wherein the method further comprises using the one or more AI models to perform a sentiment analysis procedure on the interaction to thereby determine a set of emotional states, each corresponding to an emotional state of the customer during each a corresponding portion of the interaction.
Embodiment 55 The system of embodiment 54, wherein the method further comprises using the one or more AI models to provide feedback to the agent based on the sentiment analysis procedure, thereby permitting the LLM to provide further training to the agent.
Embodiment 56 A system for increasing effectiveness of communication between an agent of a contact center and a customer, the system comprising:
   one or more processors; and
   a memory coupled with the one or more processors and configured to provide the one or more processors with instructions which when executed cause the processor to implement a method comprising:
      a. receiving a captured text or real-time transcript of an interaction between an agent of a contact center and a customer;
      b. identifying one or more documents associated with an account of the customer;
      c. using one or more artificial intelligence (AI) models to summarize information included in the one or more documents in response to the interaction; and
      d. presenting the summarized information to the agent.
Embodiment 57 The system of embodiment 56, wherein the contact center comprises a healthcare call center and wherein the customer comprises a member of a healthcare plan.
Embodiment 58 The system of embodiment 56 or 57, wherein the method further comprises, prior to (a), using the one or more AI models to generate the real-time transcript.
Embodiment 59 The system of any one of embodiments 56-58, wherein the one or more AI models comprises one or more large language models (LLMs).
Embodiment 60 The system of any one of embodiments 56-59, wherein (b) comprises identifying the one or more documents based on identifying information associated with the customer.
Embodiment 61 The system of embodiment 60, wherein the identifying information comprises one or more members selected from the group consisting of: a medical record associated with the customer, a first name of the customer, a last name of the customer, a date of birth of the customer, an address associated with the customer, a telephone number associated with the customer, an email address associated with the customer, and a social security number of the customer.
Embodiment 62 The system of any one of embodiments 56-61, wherein (b) comprises using the one or more AI models to identify the information.

Embodiment 63 The system of any one of embodiments 56-62, wherein (c) comprises using the one or more AI models to summarize the information based on one or more members selected from the group consisting of: the agent asking one or more questions of or providing one or more comments to the customer, the agent answering one or more questions or one or more comments presented by the customer to the agent, the customer answering one or more questions or one or more comments presented by the agent to the customer, and the customer asking one or more questions of or providing one or more comments to the agent.
Embodiment 64 The system of any one of embodiments 56-63, wherein the information comprises one or more members selected from the group consisting of: limits of coverage associated with a healthcare plan, details on procedures, cost, copayments, limitations, preauthorization requirements, plan premiums and deductibles, and process questions.
Embodiment 65 The system of any one of embodiments 56-64, wherein the method further comprises repeating (a)-(d) one or more times.
Embodiment 66 The system of any one of embodiments 56-65, wherein the method further comprises using the one or more AI models to generate a summary of the interaction.
Embodiment 67 The system of embodiment 66, wherein the method further comprises presenting the summary to the agent, thereby permitting the agent to learn from the interaction.
Embodiment 68 The system of embodiment 66 or 67, wherein the method further comprises presenting the summary to a supervisor of the agent, thereby permitting the supervisor to provide further training to the agent.
Embodiment 69 The system of any one of embodiments 56-68, wherein the method further comprises using the one or more AI models to perform a sentiment analysis procedure on the interaction to thereby determine a set of emotional states, each corresponding to an emotional state of the customer during each a corresponding portion of the interaction.
Embodiment 70 The system of embodiment 69, wherein the method further comprises using the one or more AI models to provide feedback to the agent based on the sentiment analysis procedure, thereby permitting the LLM to provide further training to the agent.
Embodiment 71 A system for increasing effectiveness of communication between an agent of a contact center and a customer, the system comprising:
   one or more processors; and
   a memory coupled with the one or more processors and configured to provide the one or more processors with instructions which when executed cause the processor to implement a method comprising:
      a. using one or more artificial intelligence (AI) models to generate a portion of a simulated interaction between an agent of a contact center and a simulated customer;
      b. permitting the agent to respond to the portion of the simulated interaction; and
      c. repeating (a)-(b) to thereby provide the agent with simulated experience in conducting an interaction with a customer.
Embodiment 72 The system of embodiment 71, wherein the contact center comprises a healthcare call center and wherein the customer comprises a member of a healthcare plan.
Embodiment 73 The system of embodiment 71 or 72, wherein the one or more AI models comprise one or more large language models (LLMs).
Embodiment 74 The system of any one of embodiments 71-73, wherein (a) comprises generating the portion of the simulated interaction based on at least one member selected from the group consisting of: the agent asking one or more questions of or providing one or more comments to the simulated customer and the agent answering one or more questions or one or more comments presented by the simulated customer to the agent.
Embodiment 75 The system of any one of embodiments 71-74, wherein the method further comprises using the one or more AI models to generate a transcript of the simulated interaction.
Embodiment 76 The system of embodiment 75, wherein the method further comprises presenting the transcript to a supervisor of the agent, thereby permitting the supervisor to provide further training to the agent.
Embodiment 77 The system of embodiment 75 or 76, wherein the method further comprises presenting the transcript to the agent, thereby permitting the agent to learn from the simulated interaction.
Embodiment 78 The system of any one of embodiments 71-77, wherein the method further comprises using the one or more AI models to generate a summary of the simulated interaction.
Embodiment 79 The system of embodiment 78, wherein the method further comprises presenting the summary to a supervisor of the agent, thereby permitting the supervisor to provide further training to the agent.
Embodiment 80 The system of embodiment 78 or 79, wherein the method further comprises presenting the summary to the agent, thereby permitting the agent to learn from the simulated interaction.
Embodiment 81 A non-transitory computer-readable medium comprising computer-readable instructions stored thereon causing a computer to implement a method for increasing effectiveness of communication between an agent of a contact center and a customer, the method comprising:
   a. receiving a captured text or real-time transcript of an interaction between an agent of a contact center and a customer;
   b. using one or more artificial intelligence (AI) models to determine, from the transcript, whether one or more key events have occurred in the interaction;
   c. in response to the one or more key events occurring, updating an interaction guide for the interaction; and
   d. presenting the updated interaction guide to the agent.
Embodiment 82 The non-transitory computer-readable medium of embodiment 81, wherein the contact center comprises a healthcare call center and wherein the customer comprises a member of a healthcare plan.
Embodiment 83 The non-transitory computer-readable medium of embodiment 81 or 82, wherein the method further comprises, prior to (a), using the one or more AI models to generate the real-time transcript.
Embodiment 84 The non-transitory computer-readable medium of any one of embodiments 81-83, wherein the one or more AI models comprise one or more large language models (LLMs).
Embodiment 85 The non-transitory computer-readable medium of any one of embodiments 81-84, wherein the one or more key events comprise the agent asking one or more questions of or providing one or more comments to the customer or the agent answering one or more questions or one or more comments presented by the customer to the agent.
Embodiment 86 The non-transitory computer-readable medium of any one of embodiments 81-85, wherein the one or more key events comprise the customer answering one or more questions or one or more comments presented by the agent to the customer.
Embodiment 87 The non-transitory computer-readable medium of embodiment 85 or 86, wherein (c) comprises checking off one or more checkboxes in the interaction guide in response to the one or more key events.
Embodiment 88 The non-transitory computer-readable medium of any one of embodiments 81-87, wherein the one or more key events comprise the customer asking one or more questions of or providing one or more comments to the agent.
Embodiment 89 The non-transitory computer-readable medium of embodiment 88, wherein (c) comprises adding one or more checkboxes in the interaction guide in response to the one or more key events.
Embodiment 90 The non-transitory computer-readable medium of any one of embodiments 81-89, wherein the method further comprises repeating (a)-(d) one or more times.
Embodiment 91 The non-transitory computer-readable medium of any one of embodiments 81-90, wherein the method further comprises using the one or more AI models to generate a summary of the interaction.
Embodiment 92 The non-transitory computer-readable medium of embodiment 91, wherein the method further comprises presenting the summary to the agent, thereby permitting the agent to learn from the interaction.
Embodiment 93 The non-transitory computer-readable medium of embodiment 91 or 92, wherein the method further comprises presenting the summary to a supervisor of the agent, thereby permitting the supervisor to provide further training to the agent.
Embodiment 94 The non-transitory computer-readable medium of any one of embodiments 81-92, wherein the method further comprises using the one or more AI models to perform a sentiment analysis procedure on the interaction to thereby determine a set of emotional states, each corresponding to an emotional state of the customer during each a corresponding portion of the interaction.
Embodiment 95 The non-transitory computer-readable medium of embodiment 94, wherein the method further comprises using the one or more AI models to provide feedback to the agent based on the sentiment analysis procedure, thereby permitting the LLM to provide further training to the agent.
Embodiment 96 A non-transitory computer-readable medium comprising computer-readable instructions stored thereon causing a computer to implement a method for increasing effectiveness of communication between an agent of a contact center and a customer, the method comprising:
   a. receiving a captured text or real-time transcript of an interaction between an agent of a contact center and a customer;
   b. identifying one or more documents associated with an account of the customer;
   c. using one or more artificial intelligence (AI) models to summarize information included in the one or more documents in response to the interaction; and
   d. presenting the summarized information to the agent.
Embodiment 97 The non-transitory computer-readable medium of embodiment 96, wherein the contact center comprises a healthcare call center and wherein the customer comprises a member of a healthcare plan.
Embodiment 98 The non-transitory computer-readable medium of embodiment 96 or 97, wherein the method further comprises, prior to (a), using the one or more AI models to generate the real-time transcript.
Embodiment 99 The non-transitory computer-readable medium of any one of embodiments 96-98, wherein the one or more AI models comprises one or more large language models (LLMs).
Embodiment 100 The non-transitory computer-readable medium of any one of embodiments 96-99, wherein (b) comprises identifying the one or more documents based on identifying information associated with the customer.
Embodiment 101 The non-transitory computer-readable medium of embodiment 100, wherein the identifying information comprises one or more members selected from the group consisting of: a medical record associated with the customer, a first name of the customer, a last name of the customer, a date of birth of the customer, an address associated with the customer, a telephone number associated with the customer, an email address associated with the customer, and a social security number of the customer.
Embodiment 102 The non-transitory computer-readable medium of any one of embodiments 96-101, wherein (b) comprises using the one or more AI models to identify the information.
Embodiment 103 The non-transitory computer-readable medium of any one of embodiments 96-102, wherein (c) comprises using the one or more AI models to summarize the information based on one or more members selected from the group consisting of: the agent asking one or more questions of or providing one or more comments to the customer, the agent answering one or more questions or one or more comments presented by the customer to the agent, the customer answering one or more questions or one or more comments presented by the agent to the customer, and the customer asking one or more questions of or providing one or more comments to the agent.
Embodiment 104 The non-transitory computer-readable medium of any one of embodiments 96-103, wherein the information comprises one or more members selected from the group consisting of: limits of coverage associated with a healthcare plan, details on procedures, cost, copayments, limitations, preauthorization requirements, plan premiums and deductibles, and process questions.
Embodiment 105 The non-transitory computer-readable medium of any one of embodiments 96-104, wherein the method further comprises repeating (a)-(d) one or more times.
Embodiment 106 The non-transitory computer-readable medium of any one of embodiments 96-105, wherein the method further comprises using the one or more AI models to generate a summary of the interaction.
Embodiment 107 The non-transitory computer-readable medium of embodiment 106, wherein the method further comprises presenting the summary to the agent, thereby permitting the agent to learn from the interaction.
Embodiment 108 The non-transitory computer-readable medium of embodiment 106 or 107, wherein the method further comprises presenting the summary to a supervisor of the agent, thereby permitting the supervisor to provide further training to the agent.
Embodiment 109 The non-transitory computer-readable medium of any one of embodiments 96-108, wherein the method further comprises using the one or more AI models to perform a sentiment analysis procedure on the interaction to thereby determine a set of emotional states, each corresponding to an emotional state of the customer during each a corresponding portion of the interaction.
Embodiment 110 The non-transitory computer-readable medium of embodiment 109, wherein the method further comprises using the one or more AI models to provide feedback to the agent based on the sentiment analysis procedure, thereby permitting the LLM to provide further training to the agent.
Embodiment 111 A non-transitory computer-readable medium comprising computer-readable instructions stored thereon causing a computer to implement a method for increasing effectiveness of communication between an agent of a contact center and a customer, the method comprising:
   a. using one or more artificial intelligence (AI) models to generate a portion of a simulated interaction between an agent of a contact center and a simulated customer;
   b. permitting the agent to respond to the portion of the simulated interaction; and
   c. repeating (a)-(b) to thereby provide the agent with simulated experience in conducting an interaction with a customer.
Embodiment 112 The non-transitory computer-readable medium of embodiment 111, wherein the contact center comprises a healthcare call center and wherein the customer comprises a member of a healthcare plan.
Embodiment 113 The non-transitory computer-readable medium of embodiment 111 or 112, wherein the one or more AI models comprise one or more large language models (LLMs).
Embodiment 114 The non-transitory computer-readable medium of any one of embodiments 111-113, wherein (a) comprises generating the portion of the simulated interaction based on at least one member selected from the group consisting of: the agent asking one or more questions of or providing one or more comments to the simulated customer and the agent answering one or more questions or one or more comments presented by the simulated customer to the agent.
Embodiment 115 The non-transitory computer-readable medium of any one of embodiments 111-114, wherein the method further comprises using the one or more AI models to generate a transcript of the simulated interaction.
Embodiment 116 The non-transitory computer-readable medium of embodiment 115, wherein the method further comprises presenting the transcript to a supervisor of the agent, thereby permitting the supervisor to provide further training to the agent.
Embodiment 117 The non-transitory computer-readable medium of embodiment 115 or 116, wherein the method further comprises presenting the transcript to the agent, thereby permitting the agent to learn from the simulated interaction.
Embodiment 118 The non-transitory computer-readable medium of any one of embodiments 111-117, wherein the method further comprises using the one or more AI models to generate a summary of the simulated interaction.
Embodiment 119 The non-transitory computer-readable medium of embodiment 118, wherein the method further comprises presenting the summary to a supervisor of the agent, thereby permitting the supervisor to provide further training to the agent.
Embodiment 120 The non-transitory computer-readable medium of embodiment 118 or 119, wherein the method further comprises presenting the summary to the agent, thereby permitting the agent to learn from the simulated interaction.
Embodiment 121 The method of any one of embodiments 1-10, further comprising using the one or more AI models to provide a quality assessment (QA) score to the agent.
Embodiment 122 The method of any one of embodiments 1-10, further comprising using the one or more AI models to provide a checklist of quality assessment questions indicating which quality assessment items were successfully performed by the agent during the interaction.
Embodiment 123 The method of any one of embodiments 1-10, further comprising using the one or more AI models to provide coaching tips as feedback for the agent's performance.

1. A method for increasing effectiveness of communication between an agent of a contact center and a customer, the method comprising:
a. receiving a captured text or real-time transcript of an interaction between an agent of a contact center and a customer;
b. using one or more artificial intelligence (AI) models to determine, from the transcript, whether one or more key events have occurred in the interaction;
c. in response to the one or more key events occurring, updating an interaction
guide for the interaction; and
d. presenting the updated interaction guide to the agent.

2. The method of claim 1, further comprising, prior to (a), using the one or more AI models to generate the real-time transcript.

3. The method of claim 1, wherein the one or more key events comprise the agent asking one or more questions of or providing one or more comments to the customer or the agent answering one or more questions or one or more comments presented by the customer to the agent.

4. The method of claim 1, wherein the one or more key events comprise the customer asking one or more questions of or providing one or more comments to the agent or the customer answering one or more questions or one or more comments presented by the agent to the customer.

5. The method of claim 1, wherein (c) comprises checking off one or more checkboxes in the interaction guide in response to the one or more key events.

6. The method of claim 1, further comprising using the one or more AI models to generate a summary of the interaction or to generate one or more tips for future interactions.

7. The method of claim 6, further comprising presenting the summary or the one or more tips to the agent, thereby permitting the agent to learn from the interaction.

8. The method of claim 1, further comprising using the one or more AI models to provide a quality assessment (QA) score to the agent.

9. The method of claim 1, further comprising using the one or more AI models to provide a checklist of quality assessment questions indicating which quality assessment items were successfully performed by the agent during the interaction.

10. The method of claim 9, further comprising updating the interaction guide based on one or more insight questions.

11. The method of claim 10, further comprising surfacing one or more interaction attributes based on the one or more insight questions.

12. A method for increasing effectiveness of communication between an agent of a contact center and a customer, the method comprising:
a. receiving a captured text or real-time transcript of an interaction between an agent of a contact center and a customer;
b. identifying one or more documents associated with an account of the customer;
c. using one or more artificial intelligence (AI) models to summarize information included in the one or more documents in response to the interaction; and
d. presenting the summarized information to the agent.

13. The method of claim 12, further comprising, prior to (a), using the one or more AI models to generate the real-time transcript.

14. The method of claim 12, wherein (b) comprises identifying the one or more documents based on identifying information associated with the member.

15. The method of claim 12, wherein (b) comprises using the AI model to identify the information.

16. The method of claim 12, wherein (c) comprises using the AI model to summarize the information based on one or more members selected from the group consisting of: the agent asking one or more questions of or providing one or more comments to the member, the agent answering one or more questions or one or more comments presented by the member to the agent, the member answering one or more questions or one or more comments presented by the agent to the member, and the member asking one or more questions of or providing one or more comments to the agent.

17. The method of claim 12, further comprising using the one or more AI models to provide feedback or recommendations to the agent, thereby permitting the LLM to provide further training to the agent.

18. The method of claim 12, wherein the feedback is based on recent interactions between the customer and the contact center.

19. The method of claim 17, further comprising using the one or more AI models to perform a sentiment analysis procedure on the interaction to thereby determine a set of emotional states, each corresponding to an emotional state of the customer during each a corresponding portion of the interaction.

20. The method of claim 19, wherein the feedback comprises one or more recommended actions for the agent to perform based on the sentiment analysis procedure.

21. The method of claim 17, further comprising permitting the agent or a supervisor of the agent to accept, reject, or comment upon the feedback or recommendations, thereby permitting additional training of the one or more AI models.

22. A method for increasing effectiveness of communication between an agent of a healthcare service center and a member of a healthcare plan, the method comprising:
a. using an artificial intelligence (AI) model to generate a portion of a simulated interaction between an agent of a healthcare service center and a simulated member of a healthcare plan;
b. permitting the agent to respond to the portion of the simulated interaction; and
c. repeating (a)-(b) to thereby provide the agent with simulated experience in conducting an interaction with a member of the healthcare plan.

23. The method of claim 22, wherein (a) comprises generating the portion of the simulated interaction based on at least one member selected from the group consisting of: the agent asking one or more questions of or providing one or more comments to the member and the agent answering one or more questions or one or more comments presented by the member to the agent.

24. The method of claim 22, further comprising using the AI model to generate a transcript of the simulated interaction.

25. The method of claim 24, further comprising presenting the transcript to a supervisor of the agent, thereby permitting the supervisor to provide further training to the agent.

26. The method of claim 24, further comprising presenting the transcript to the agent, thereby permitting the agent to learn from the simulated interaction.

27. The method of claim 22, further comprising using the AI model to generate a summary of the simulated interaction.

28. The method of claim 27, further comprising presenting the summary to a supervisor of the agent, thereby permitting the supervisor to provide further training to the agent.

29. The method of claim 27, further comprising presenting the summary to the agent, thereby permitting the agent to learn from the simulated interaction.

30. The method of claim 24, further comprising: using the one or more AI models to determine, from the transcript, whether one or more key events have occurred in the simulated interaction; in response to the one or more key events occurring, updating an interaction guide for the simulated interaction; and presenting the updated interaction guide to the agent.

31. The method of claim 22, further comprising: using the one or more AI models to generate a summary of the simulated interaction or to generate one or more tips for future interactions; and presenting the summary or the one or more tips to the agent, thereby permitting the agent to learn from the simulated interaction.
